(19) United States
(12) Patent Application Publication
(10) Pub. No.: US 2009/0048873 A1
(43) Pub. Date: Feb. 19, 2009

(54) Method and system to manage coronary artery disease care

(76) Inventor: Sultan Haider, Erlangen (DE)

Correspondence Address: BRINKS HOFER GILSON & LIONE, P.O. BOX 10395, CHICAGO, IL, 60610, US

(21) Appl. No.: 11/893,664

(22) Filed: Aug. 17, 2007

(51) Int. Cl. G06Q 50/00; G06F 17/30

(52) U.S. Cl. 705/3

(57) ABSTRACT

A system and method updates the status of an individual care plan to be performed at different locations. Worksteps of the care plan may be performed at a number dispersed medical facilities and/or specialists. Data regarding a workstep may be locally entered at the facility that performs the workstep. A data base of the individual care plan may then be updated, and subsequently remotely accessed via a communications network by other medical facilities to view the current status of the care plan. For instance, before a current workstep is performed, medical personnel may view textual information detailing and images acquired during the performance of a previous workstep performed at a different facility. As a result, an effective and efficient means of transferring information regarding the patient and care plan among medical facilities is provided.

### TECHNICAL FIELD

The present application relates generally to the improvement of medical treatment. In particular, aspects of tracking the patient status and selection of worksteps for follow up or emergency treatment are addressed.

### BACKGROUND

Coronary artery disease (CAD), which is the end result of the accumulation of atheromatous plaques within the walls of the arteries that supply the myocardium, remains the number one cause of disability and death in modern industrialized countries. In 2005 the estimated direct and indirect cost of CAD in the US is $393.5 billion. In the US in 2001 nearly 900.000 Americans experienced a new or recurrent heart attack, or acute myocardial infarction. Chest pain (angina pectoris) may also occur.

Risk mitigation strategies include weight control, treatment or prevention of diabetes, physical exercise, and special diets that are low in salt or fat may be recommended. Outpatient treatment with drugs on a short or long-term basis may also be indicated.

For more acute symptoms of CAD, coronary catheterization is a minimally invasive imaging method of choice for interventional therapy of occlusion, stenosis, restenosis, thrombosis or aneurysmal enlargement of coronary arteries. In addition to information on lesion size and luminal narrowing, interventional procedures are able to directly access the region to be treated via the arterial system. In the US, more than 664,000 percutaneous transluminal coronary angioplasties (PTCAs) were performed in 2003. However, invasive intervention such as surgery may be required.

Patients may be advised to take certain medications, participate in sports programs and the like. Most patients discharged from a hospital after treatment are referred to general physicians. The patients may be monitored on a long term basis for changes in metabolic parameters, which may include blood chemistry, so that the treatment plan can be adjusted accordingly.

A range of metabolic factors such as may be obtained from blood tests, such as cholesterol level including total cholesterol, high- and low-density cholesterol, triglycerides, biomarkers such as high sensitivity C-reactive protein, homocysteine and blood sugar control (hemoglobin A1c) and other measurements such as basal metabolic rate (BMR) and body mass index may also be measured on a periodic basis depending on the treatment plan.

If an acute aspect of CAD is encountered, such as a suspected heart attack, the patient generally goes to a hospital emergency room, since rapid treatment is a leading indicator of successful treatment outcomes. Often, however, the patient is being treated in a hospital other than that in which the previous treatment or diagnosis has occurred, and the physician with knowledge of the case, and the appropriate medical records are not immediately available. This circumstance leads to delays in treatment, while a medical history is obtained, and laboratory tests and imaging studies performed and interpreted. The drugs being taken by the patient may not be known. The emergency room physician may not have access to previous tests, such as electrocardiograms (EKG), imaging studies such as computerized tomography (CT), magnetic resonance (MR) or ultrasound (US), or to a record of previously performed procedures.

Often, the temporal changes in metabolic function over a period of months or years, changes in morphology identified by imaging, and the like, contribute to the speed and accuracy of diagnosis of the current syndrome, or the ruling out of CAD. Apart from reducing the time and costs of emergency treatment by avoiding duplicative tests, the speed of treatment has a beneficial impact on the clinical outcome.

Other medical data and family data may also be relevant to the prompt and effective diagnosis of CAD, including cardiovascular risk factors (family history, smoking, high blood pressure, high cholesterol, diabetes), diet, exercise history, weight history, and previous electrocardiograms (EKG) and imaging studies.

At present, there is no system that organizes and preserves patient medical history, treatment and test data, where the information can be made available to medical professionals rapidly and in an organized manner.

Conventional medical treatment plans may result in the individual steps of a care plan being performed at different medical facilities or by different specialists located at dispersed locations, and over a period of time. However, the flow of information regarding the patient and the care plan between the different medical facilities and/or personnel may be incomplete or inefficient. For instance, each different facility may maintain its own medical records or data base, which other facilities may not have access to. The data base formats may by different and incompatible. Additionally, the treatment administered at one facility without such treatment or the results thereof being known to other facilities. As a result, confusion may result between the medical personnel treating the patient at different locations, and unnecessary, redundant, or inappropriate medical treatment may be performed.

Thus, conventional workflows and software applications related to the detection and treatment of coronary artery disease (CAD) have limitations. The limitations may be associated with the inefficient sharing, or lack of sharing, or lack of preserving, of the information, such as information regarding the status of the patient and the healthcare that the patient has previously received to treat the CAD, between medical personnel and/or facilities.

### BRIEF SUMMARY

A system and method may maintain a care plan of an individual patient, up-to-date. A number of medical facilities may be interconnected via a communications network, such as the Internet, that permits the transfer of information among and between the medical facilities. Each time a workstep within the care plan is performed at one of the medical facilities, the information regarding the care administered to the patient may be entered at that medical facility via a user interface to update a data base associated with the care plan. The data base may be locally or remotely located. When a next workstep within the care plan is to be performed at a medical facility, which may not be the same facility as preformed the first workstep, medical personnel at that facility may remotely access and display up-to-date data of the individual care plan. The workstep performed at the first facility may be re-performed at the first facility or the second facility as is appropriate for the circumstances. As a result, the medical personnel at the next or subsequent medical facility may efficiently learn what care was administered to the patient at other medical facilities during previously performed worksteps within the specific individual care plan. The care plan may involve a workflow assisted by one or more interactive software applications or by acquiring internal medical images of the patient via medical imaging devices or by performing laboratory tests and examinations.

In an aspect, a method of health care facilitates cross-institutional healthcare. The method includes maintaining a date base containing a care plan for an individual patient up-to-date by integrating medical information regarding or obtained by individual worksteps associated with the care plan via a processor, which may be a general or special purpose computer and peripheral equipment, the individual worksteps being performed at one or more medical facilities. The method also includes providing remote access to data associated with the worksteps in the care plan over a communications network such that the data may be reproduced to display a current status of the care plan at a remote location.

In another aspect, a method facilitates cross-institutional healthcare. The method includes updating a data base of a care plan for an individual patient using workstep data associated with a performance of a workstep within the care plan, the workstep being performed at a first medical facility. The method also includes providing remote access to data via a communications network associated with the dynamically updated representation of the care plan such that the updated data base may be accessed at a second medical facility so as to display information regarding the performance of the workstep within the care plan performed at the first medical facility.

In another aspect, a data processing system facilitates cross institutional healthcare. The system includes a data processor operable to remotely receive data from a plurality of medical facilities regarding a care plan for a specific individual patient over a communications network, the care plan comprising a plurality of worksteps to be performed among the plurality of medical facilities; dynamically maintain the current status of the care plan for the patient up-to-date using the data received; and providing remote access to a machine readable representation of the up-to-date care plan over the communications network, such that each of the plurality of medical facilities may locally reproduce the machine readable representation of the up-to-date care plan.

In yet another aspect, a computer-readable medium provides instructions executable on a computer. The instructions configure the computer to be operable to dynamically update a representation of a care plan for an individual patient using first workstep data regarding the performance of a first workstep associated with the care plan at a first medical facility. The instructions also include providing remote access to the updated data base of the care plan such that the updated data base of the care plan may be accessed so as to display a current status of the care plan at a second medical facility. If follows that, similarly, data regarding any workstep performed at the second medical facility may be used to update the data base associated with the individual patient care play, and be accessible at any of the authorized facilities.

### BRIEF DESCRIPTION OF THE DRAWINGS

FIG. 1 illustrates an exemplary technique of dynamically updating a medical care plan;

FIG. 2 illustrates an exemplary interconnected network;

FIG. 3 illustrates an exemplary user interface for maintaining a medical care plan up-to-date and sharing information among medical institutions performing a single care plan;

FIG. 4 illustrates an exemplary screen of the user interface associated with FIG. 3;

FIGS. 5 and 6 illustrate other exemplary user interface screens; and,

FIG. 7 illustrates an exemplary data processor configured or adapted to provide the functionality for maintaining an overview of a medical care plan and workstep information associated with the performance of the medical care plan up-to-date.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may be stored at a remote location for transfer through a computer network, a local or wide area network, or over telephone lines. In yet other embodiments, the instructions are stored within a particular computer or system.

The instructions may be a computer program product, stored or distributed on computer readable media, containing some or all of the instructions to be executed on a computer to perform all or a portion of the method or the operation of the system.

The terms “treatment plan”, “care path”, “clinical care plan” or similar terms, as used herein, refers to a medical workflow that includes a number of worksteps associated with the diagnosis and/or treatment of an illness or syndrome. For example, typical worksteps within a care plan may include screening, diagnostic testing, therapy, physical examinations, operations, ambulance transportation, out-patient care, in-patient care, cardiovascular-related care, and other steps. Worksteps may include a sequence of process steps, the use of specified treatment or diagnostic equipment, medical supplies, such as contrast agents, stents, drugs, medical appliances, transportation of the patient, and performing medical procedures requiring at least one of non-invasive, minimally invasive, or invasive aspects, and the like.

The examples of illnesses, syndromes, conditions, and the like, and the types of examination and treatment protocols described herein are by way of example, and are not meant to suggest that the method and system is limited to those named, or the equivalents thereof. As the medical arts are continually advancing, the use of the methods and system described herein may be expected to encompass a broader scope in optimizing the diagnosis and treatment of patients.

A workstep within the care plan may have an associated machine readable form of a written description, graphical depiction, table, text, article, flowchart, or other machine readable representation of the best way of performing the workflow that is displayable via the user interface. For example, a graphic, a table, or other visual representation may be presentable to the user that displays the process steps (such as a graphic depiction of the workstep, along with corresponding textual and/or audio information) of the process and the corresponding clinical treatment guideline. The sequence of worksteps in a process may be determined on a rule basis, and the each of the rules in the rule basis may have either a deterministic or probabilistic character. The rules may be embodied in algorithms or equations operating on the patient specific data and producing recommendations or guidance that may be displayed for use of the medical personnel.

A “medical facility” as used herein is considered to encompass any location, whether temporary or permanent, where medical treatment may be performed or managed. This includes, but is not limited to hospitals, clinics, nursing facilities, physicians offices, emergency response vehicles, insurance providers, and the like where access to the data is permitted.

A “customer” or “user” as used herein is considered to encompass medical personnel of all types and functions, including administrative personnel. The level of access to the data of an individual care plan may be limited depending on the function of the user and the relationship of the user to the patient.

Medical data systems may be used collect information on patients, including medical history, demographic information, results of medical tests, prior treatment, including specific worksteps and outcomes, and other information related to individual patients. Generally, the course of treatment, or care path for a patient is based an electronic formula or other algorithm, with the detailed course of treatment based on the symptoms, tests and patient response to treatment. Each medical facility may have different suites of treatment and diagnostic equipments, and constraints on the use thereof due to scheduling conflicts. The specific staff skills and experience, costs, and clinical outcomes may suggest modifications of the care path, based on an ensemble of patient histories.

The patient-specific data entered may be used to update, via a processor, a representation of the care plan stored in either a local or a remote data base accessible over a communications network. Other medical facilities that perform subsequent worksteps within the care plan may then remotely access and locally display the updated data base of the care plan to ascertain the current status of the patient/care plan, such as before performing the next or other subsequent workstep within the care plan.

The embodiments described herein include methods, processes, apparatuses, instructions, systems, or business concepts for maintaining a medical care plan for a patient up-to-date. The care plan may be administered via a number of medical facilities and/or medical personnel, such as specialists, located at dispersed locations. After a workstep within the care plan is administered at one medical facility, the care plan may be updated. For instance, data regarding the status of and /or details regarding the results of the workstep performed, as well as other patient information may be entered by medical personal located at that medical facility via a user interface.

The data entered may be used to update, via a processor, a data base of the individual care plan stored in either a local or a remote data base accessible over a communications network. Other medical facilities that perform subsequent worksteps within the care plan may then remotely access and locally display the updated data base of the care plan to ascertain the current status of the patient/care plan, before performing the next or other subsequent workstep within the care plan.

The system and method may include a software application operable on a computer to present an overview of the patient care path that is to be performed among a number of healthcare institutions and/or specialists. The software application may include a user interface that implements access rights or other security measures. The user interface may provide user management at one facility with access to data associated with the care plan collected at other facilities.

Within the care path solution plan, a medical professional may be allowed to work within a certain area of the care plan and be presented with the relevant data associated with that area. This may include presenting (1) the cost of a single step within a treatment workflow (which may support a new financing model); (2) who (i.e., medical facility and/or specialist) is allowed to perform a single step within the care plan (which may be a tool for user management); (3) pre-selections and/or pre-configurations associated with a specific medical professional and/or institution (such as automatically saved settings for medical equipment and software applications); (4) who (i.e., medical facility and/or specialist) previously performed a workstep and when (which may be a tool for monitoring and evaluation); (5) automatically creating a link within data stored as a medical record/file (such that workstep data stored at different locations in different data bases may be linked to a single care plan); (6) a system that automatically learns about different display views presented through user selection (such as automatically saving user preferences and user interface settings); and (7) algorithms that evaluate data (e.g., if facility A sends a patient to facility B, facility B evaluates work performed at facility A, such as an image acquired by facility A in CAD diagnosis is evaluated by facility B) and identify patterns or trends. The above steps may be applicable or modified to be applicable to other types of cross institutional care plans.

In another aspect, the system and method may include using a rule engine, a care path implementation system, a data base, and input and output mechanisms. The care path may be implemented and programmed in an electronic formula or other algorithm. The fields in the formula may be linked to a data base, either remote or local, such as a Microsoft SQL-data base with a SQL (Structured Query Language) server. Other data bases, as are known in the art, may be used. The system may be operable to add, delete, and/or select data (such as text and/or images) from data files. The system may offer a search mechanism, such as a search engine, operable to search remote data bases. For instance, medical personnel at one facility may be able to remotely search a data base stored at another facility involved with the performance of the care plan to gather information about the care plan, worksteps within the care plan previously performed or yet to be performed, and other information regarding the patient, including patient characteristics and other healthcare data relating to the patient which may be unrelated to the present care plan (such as medications previously or currently prescribed for the patient, and past illnesses treated).

In yet another aspect, an insurance policy number or other unique individual identifier from the basic claims data may be used as a search criterion among medical facilities. Under a “Patient Status” menu, a user interface may provide access to and display check-up information of individual patients. An option to select a workstep called “CAD History” via the user interface may be presented at various times/places, such as with a button entitled “Rescreening.” Another button may be operable to accept a user operation directing the performance and presentation of various evaluations of the data gathered, such as a button entitled “Evaluation for diagnostic and therapy decisions.” Other buttons may be entitled “Individual Therapy,” “Operation,” “Ambulance,” and “Cardiology,” and provide functionality for entering and displaying information for corresponding worksteps, which may include functionality described herein. Other buttons may provide other functionality and be associated with other worksteps.

The advantages of the present embodiments may include the ability to associate a software module operable to provide the functionality discussed herein with another software application, such as Soarian Integrated Care™ (SIC) software from Siemens (Munich, Germany), and/or receiving patient data from a SIC or other data base and saving the information in an external data base as structured data. The present embodiments may provide for data mining data bases associated with other non-co-located medical facilities, which is advantageous as current techniques may not accommodate data mining with SIC or other data bases. Additionally, current information storage techniques may store data in an unstructured manner that limits effectively and efficiently searching data stored among a plurality of facilities or storage media.

In an aspect, the individual patient care plans may be accomplished employing one or more interactive software applications used by customer personnel at various customer locations. The care plans and associated software applications may assist medical personnel located at hospitals and other medical facilities to diagnose and treat patients. The care plans and software applications may support medical imaging techniques and devices.

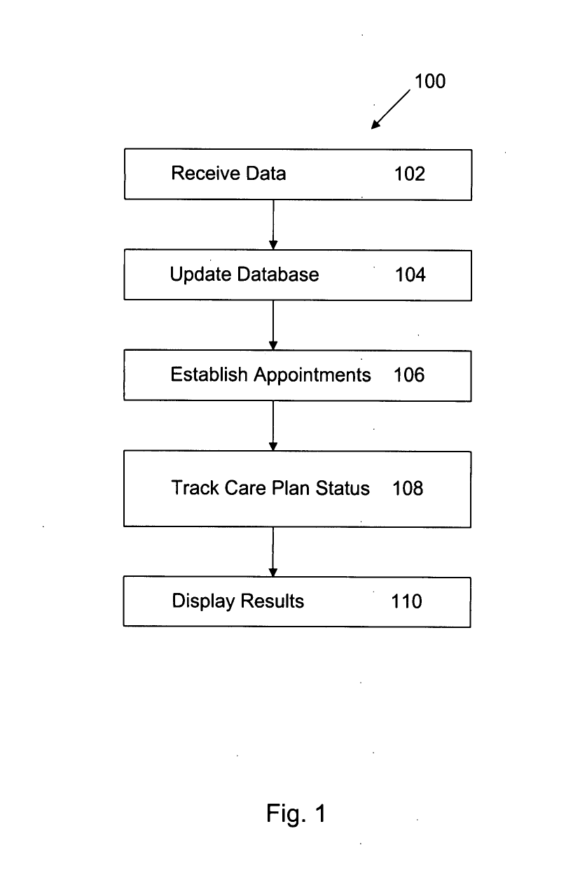

FIG. 1 illustrates a method 100 of maintaining an up-to-date machine readable data base of information on a care plan being administered to an individual patient 100 such that the current status of the care plan and other workstep information may be locally or remotely ascertained. The method 100 may include receiving data 102, updating a data base 104, establishing appointments 106, tracking the care plan status 108, and displaying results 110. The method may include additional, fewer, or alternate actions. The appointment 106 may include medical tests and procedures.

The step of receiving data 102 may include data received from a local machine or manually input to a computer terminal. Alternatively, the data may be remotely received from other medical facilities over a communications network, such as the Internet or other wired or wireless telecommunications network.

The data may be entered via a user interface by medical personnel at individual medical facilities or workstations. The data may include data related to a care plan involving a number of worksteps. For instance, the data may relate to patient information, performance and/or status of a workstep within the care plan, and appointment information. The data may include image data acquired during a workstep that a user attaches, downloads, or otherwise links to the care plan information. Alternatively, image data may be automatically linked to a data base of the care plan and accessible therefrom via a user interface. Other types of data may be received and/or linked to a data base of the care plan. In one embodiment, the user interface is the user interface discussed herein below. Other user interfaces may be used.

The method 100 may include updating a data base 104. The data base may be updated using the data entered by medical personnel at one or more of the medical facilities. The data base updated may be a local data base located at an individual medical facility, or a remote data base, which a plurality of medical facilities have access to, or a combination of both local and remote data bases.

The data received may be used to update a machine readable data base of a care plan and/or associated worksteps within the care plan. The updated data base may then be stored in the data base as a manner of updating the data base 104. Other patient information received also may be stored in the data base. The data stored may be stored in a known or after developed structured format such that the updated data base is searchable via known searching techniques and rules, such as by entering search terms.

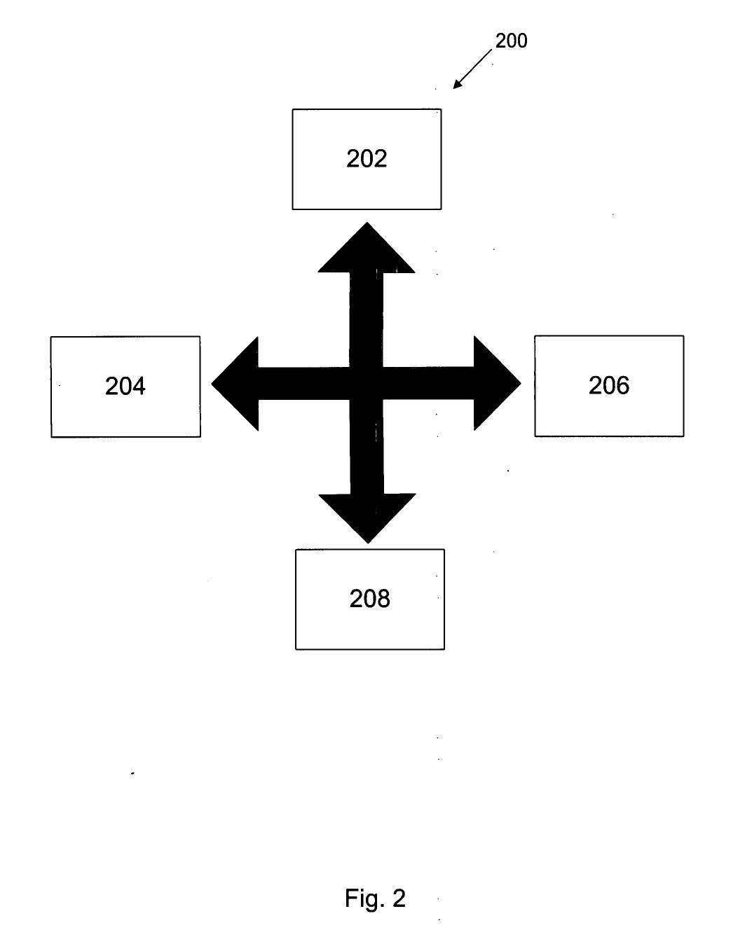

FIG. 2 illustrates an exemplary interconnected network 200. The interconnected network 200 may connect a plurality of medical facilities. The network 200 may include integrating access to a Soarian Integrated Care (available from Siemens, Munich, Germany) or other application 202, a care plan implementation 204, a data base 206, and medical rules 208. The network may include additional, fewer, or alternate components. In one aspect, the network 200 implements a care plan associated with the detection and treatment of CAD. Other care plans may be implemented.

The network 200 may include local or remote access to one or more Soarian Integrated Care or other software solutions 202. Personnel at remote medical facilities may remotely access Soarian™ or other medical applications that facilitate the treatment and diagnosis of patients.

The network 202 may include a local care plan implementation 204. The local care plan implementation 204 may be tailored for individual medical facilities to account for the specific resources, such as available equipment and personnel. The local care plan implementation 204 may be a software application that facilitates a care plan of a patient. The local care plan implementation 204 may have a dedicated user interface or implement equipment settings specific to a medical facility.

The network 206 may be interconnected with one or more data bases 206. A data base may be local or physically located at a medical facility. Alternatively or additionally, one medical facility may access data bases located a central location and/or other medical facilities. All of the data bases may store medical data in a structured manner such that the medical data is searchable. Each interconnected medical facility may access and retrieve medical files, patient information, and other data stored in the data bases of other medical facilities that are also involved with administering the care plan to the patient.

The network 200 may have associated medical rules 208. The medical rules 208 may be based upon or define clinical pathways, customer specifications or requirements, and other guidelines. Alternate rules may be used. The rules may facilitate searching each of the interconnected data bases such that data mining of medical data collected and stored within a data base at one medical facility may be remotely searchable from other interconnected facilities also involved with the performance of the care plan.

In an aspect, the method 100 may include establishing appointments 106. Times and dates for future appointments may be entered via a user interface. Other information regarding the appointments, such as specific instructions, planned tests, and recommendations, may be entered.

Notes and instructions regarding an appointment may be entered and subsequently accessed via the user interface. After an appointment occurs, the results and subsequent plan for further treatment may be summarized and entered via the user interface for storage within a data base. The user interface permits medical personnel located at different and remote locations to all have access to the appointment schedule and results thereof of the patient/care plan.

The method 100 may include tracking the current status of a care plan of a patient 108. As noted above, after an appointment, information regarding the patient and/or treatment provided or tests performed during the appointment may be entered and saved to a data base. For example, information regarding each workstep to be performed within the care plan during the appointment may be stored in the data base and accessed for visual reproduction via the user interface.

The method 100 may include displaying the results generated 110. A machine readable representation of the care plan or an overview thereof may be stored in one or more data bases. The data base of the care plan may be remotely and/or locally accessed at each medical facility interconnected with the network. As a result, the computer data base of the care plan may be reproduced at each medical facility such that the current status of the care plan and information regarding the performance of previous worksteps may be textually, graphically, audibly, and/or pictorially displayed.

An individual care plan may be a “best practice” workflow, or a workstep, or a best practice workstep that accounts for individual patient characteristics, such as sex, age, diseases, past and current illnesses, weight, height, allergies, symptoms, religion, race, ethnicity, medical history, and other characteristics of the patient. In one embodiment, the best practice care plan/workstep may account for the geographical region or location of the customer. For example, a hospital in a certain country may treat mostly patients of a specific race, ethnicity, or other characteristic, or certain syndromes may occur with greater frequency in a local population.

Generally, the worksteps of the care plan may be validated or certified by associating the clinical processes to established clinical guidelines and may be verified by experienced physicians or by quality review procedures. A workstep within the care plan may have an associated machine readable form of a written description, graphical depiction, table, text, article, flowchart, or other machine readable data base of the best way of performing that workflow that is displayable via the user interface. For example, a graphic, table, or other visual data base may be presentable to the user that displays the process steps (such as a graphic depiction of the workstep, along with corresponding textual and/or audio information) of the implemented process and the corresponding clinical guideline.

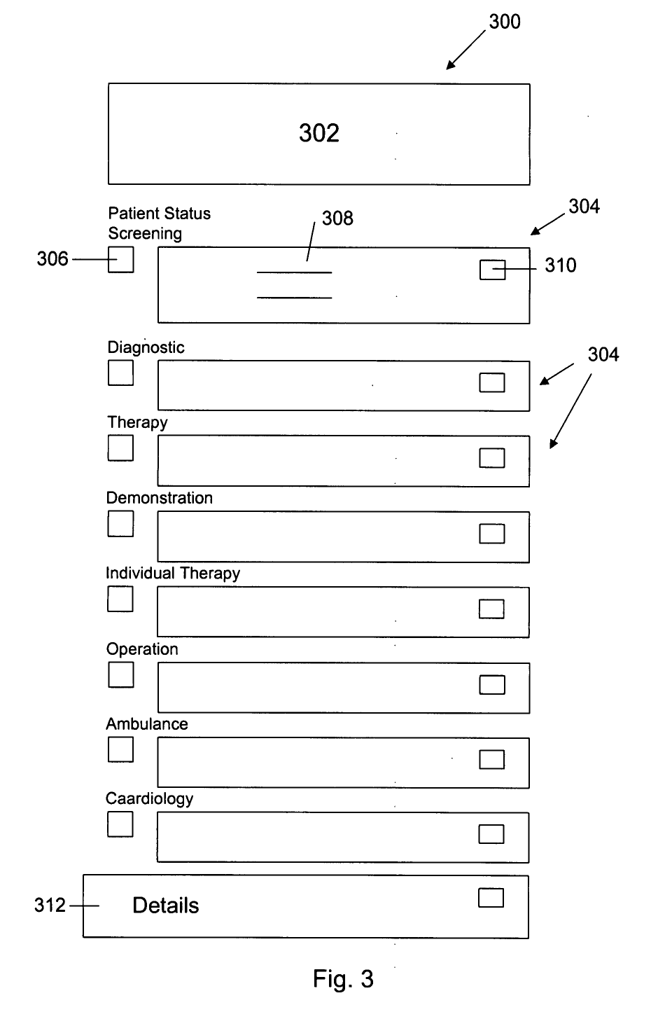

FIG. 3 illustrates an exemplary user interface 300 for maintaining an individual medical care plan up-to-date and sharing information regarding the care plan and associated worksteps among medical institutions performing the care plan. The user interface 300 may include a master data section 302, workstep sections 304, status boxes 306, text display 308, input buttons 310, and a details section 312. The user interface may include additional, fewer, or alternate components.

The user interface 300 may include a master data section 302. The master data section 302 may summarize characteristics of the patient. The master data section 302 may be part of a window or be a dedicated window.

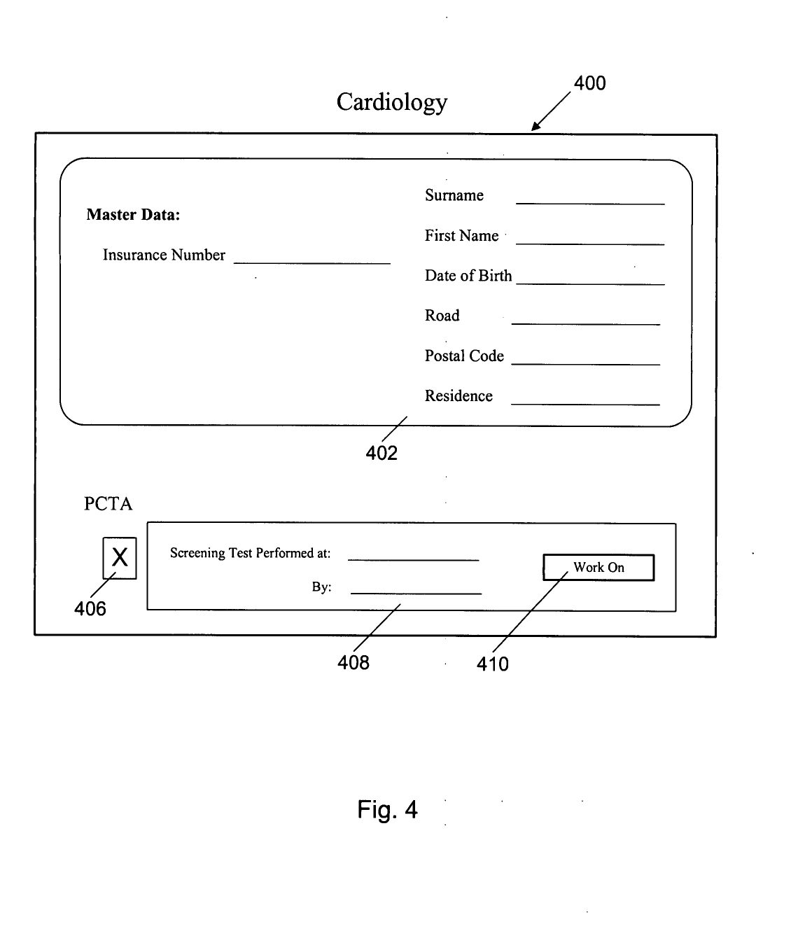

FIG. 4 illustrates an exemplary portion of a user interface 400. As shown, the master data 402 may include data related to the patient's health insurance or identification number, surname, first name, date of birth, and residence or contact address. Other master data 402 may be used. For example, master data detailing patient characteristics, such as age, sex, height, weight, illness, and other patient information may be displayed.

The user interface 300 may include a number of workstep sections 304. In the example shown, the worksteps that define the current patient status include worksteps directed toward patient screening, diagnostics, individual therapy, operation, ambulance transportation, and cardiology. Other worksteps may be used. For instance, in-patient and out-patient care worksteps may be included.

A status box 306 may be associated with each workstep box 304. The status box 306 associated with a workstep 304 may be marked with an “X” if that workstep is completed. Otherwise the status box 306 may be blank. As a result, a current status with respect to the completed, as well as outstanding, worksteps within the care plan may be readily ascertained. Additionally, or alternatively, the status of worksteps may be colored coded. A workstep 304 may have a green background if completed, yellow background if partially completed, and red if completely outstanding. Other coloring schemes may be used.

Each workstep box 304 may display textual information 308 associated with the workstep. Each workstep box 304 may have one or more input buttons 310 for accepting instructions or other input operations from a user. An input operation performed on the buttons 310, such as via a mouse, keyboard, or touch screen, may result in further information about the workstep being displayed. For instance, the results of the workstep may be displayed if the workstep has already been performed. On the other hand, if the workstep is yet to be performed, instructions or other recommendations may be displayed. Alternatively, a best practice method of performing the workstep may be textually and/or visually displayed.

As shown in FIG. 4, the user interface 400 for a workstep related to diagnosing or treating CAD may include a status box 406 that indicates whether the workstep has been performed or not. In one aspect, a displayed “X” may indicate that the workstep has been completed. The workstep information may include text information 408, such as information detailing who (e.g., which medical facility and/or specialist) performed the workstep, and when and where it was performed.

The workstep information may have an input button 410, such as the “work on” button shown. By performing an input operation, such as a mouse click, on the input button 410, a user performing the workstep may be presented with another screen that permits the entry of detailed information regarding the performance of the workstep. The detailed information may be saved to a local or remote data base. Subsequently, medical personnel at the same or other medical facilities may be able to access and view the information entered by the person that performed the workstep.

The user interface 300 may have a details box 312. The details box 312 may be associated with displaying or summarizing the results of evaluations of medical facility and/or personnel performance. For example, the results of evaluations or other analysis may be summarized, such as in table or chart. The results may be color coded, such as green for best performance, and red for worst.

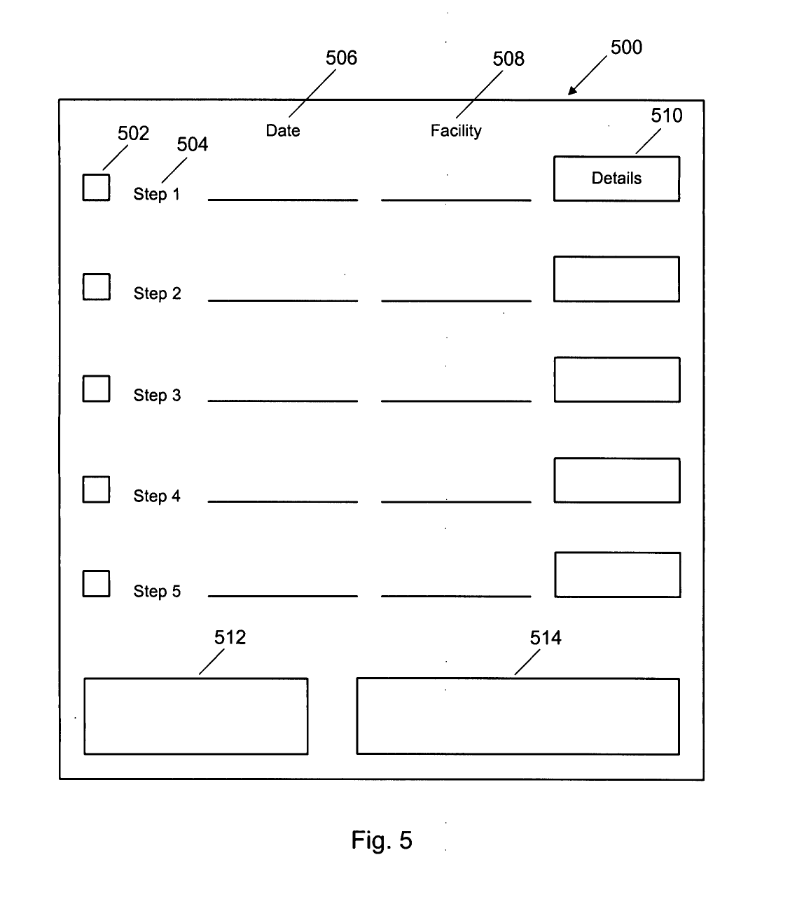

FIG. 5 illustrates another exemplary user interface 500. The user interface 500 may include status boxes 502, representations of a number of worksteps 504, date information 506, facility information 508, input buttons 510, and other input buttons 512, 514. The user interface 500 may be separate from or part of a screen associated with the display of the user interface 300 of FIG. 3. For instance, the user interface screen section 500 of FIG. 5 may be displayed under the user interface screen section 300 of FIG. 3 in a single display. The user interface 500 may include additional, fewer, or alternate components.

The status boxes 502 may indicate whether or not a workstep 504 has been completed. The date 506 and facility 508 at which a workstep is scheduled to be performed or has already been performed at may be identified. For instance, a user may enter appointment information associated with the workstep 504, such as date and facility. The data entered may be saved to a data base, such as via an input operation performed on button 512. Button 514 may provide access to another screen for the entering of notes and instructions regarding one or more worksteps.

The details button 510 may provide access to a screen that displays textual, graphical, audio, and/or video instructions about a workstep to be performed. Alternatively, the button 510 may provide access to a screen that permits a user to enter data regarding the result of a workstep actually performed. For instance, the results of a workstep may textually summarized by a user and saved to a local or remote data base. Or, images acquired during the workstep may be linked to a corresponding results screen displayed via an operation being performed on the details button 510.

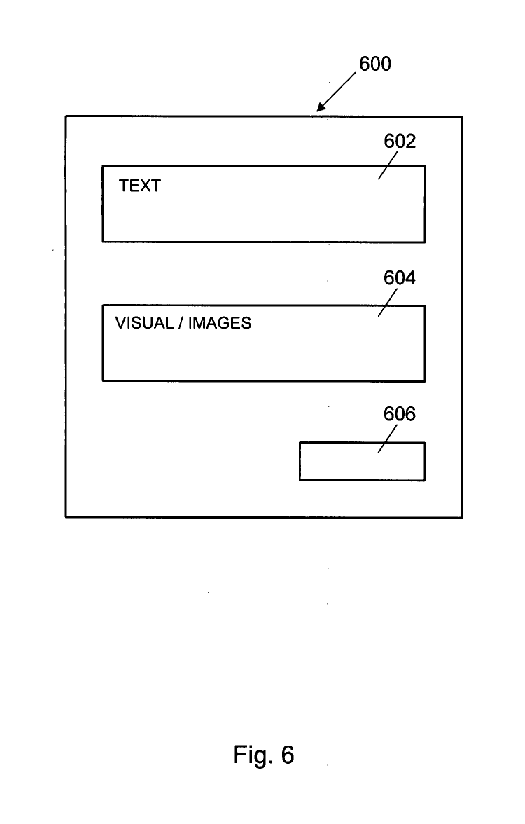

FIG. 6 illustrates an exemplary details screen 600. As mentioned directly above, the user may access textual information regarding the results of a workstep and/or actual medical images acquired during the workstep. Medical personnel that have recently completed the workstep may summarize the results of the workstep by entering text in the text box 602. Additionally, images or results of laboratory tests of a patient acquired during the workstep may be linked to the details screen 600 for display in the images box 604. A number of images may be displayed in the images box 604 and be scrollable. An input button 606 may allow for data entered to be saved to a data base for subsequent reproduction by other medical personnel. In one embodiment, the text box 602 displays information regarding a workstep related to the treatment of CAD and the images box 604 displays medical images acquired during the workstep.

The user interface may be modifiable by user. For instance, a user may be able to add additional patient fields within the portions of the user interface associated with individual worksteps. The user also may add sections for new worksteps to be included within a care plan. Alternate customizations to the user interface may be made.

The user interface may provide a manner of cross-institutional transfer of information. The user interface provides a mechanism for tracking the screening of patients and an overview of past care that the patient has received, and the efficient transfer of information among a plurality of medical facilities. The user interface may provide a manner of communicating the care plan for a patient among a number of facilities and ensure quality is maintained. Maintaining quality may be facilitated by the aspect of the user interface that may permit access to best practice care plans and individual worksteps. In one embodiment, diagnosis of CAD is performed according to a best practice workflow and/or standardized guidelines, such that the syndrome may be rapidly identified and the course of treatment such as PCTA performed in a timely manner.

Additionally, by tracking the status of appointments and the care plan, costs associated with healthcare may be reduced. Redundant medical care may be eliminated, as worksteps already performed may be easily ascertained via an overview of the care plan being displayed. Additionally, exams, procedures, and other worksteps that remain to be completed may be readily ascertained without undue delay and promptly performed without any need to directly contact medical personnel at other facilities, such as via telephone.

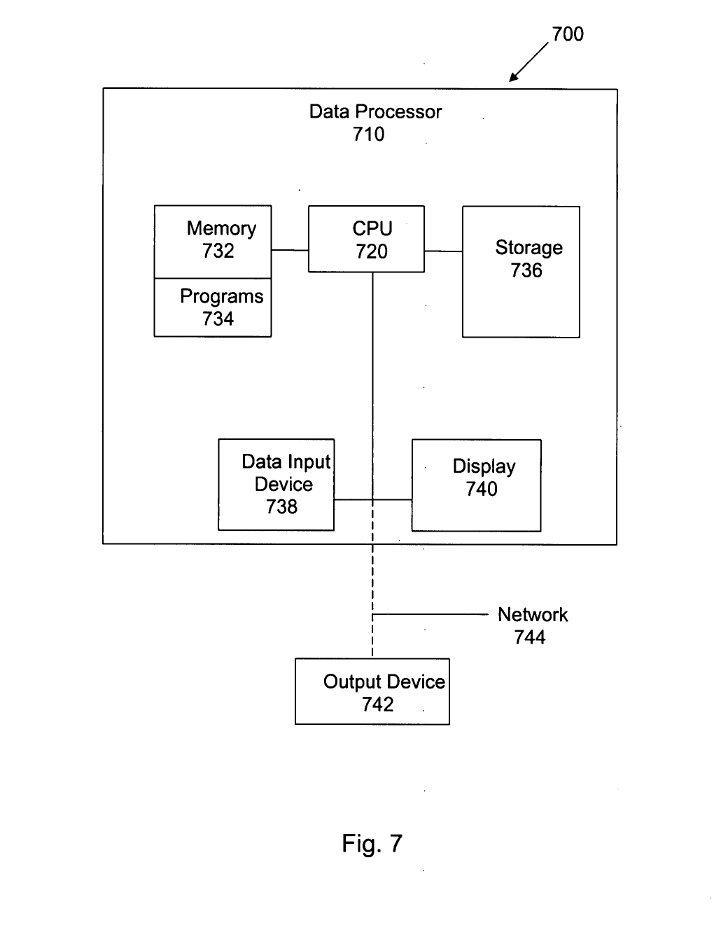

FIG. 7 illustrates an exemplary data processor 710 configured or adapted to provide the functionality for maintaining a care plan performed at a number of dispersed medical facilities up-to-date. The data processor 710 may be located at a central location. The data processor may include a central processing unit (CPU) 720, a memory 732, a storage device 736, a data input device 738, and a display 740. The processor 710 also may have an external output device 742, which may be a display, a monitor, a printer or a communications port. The processor 710 may be a personal computer, work station, Siemens PACS (Picture Archiving and Communications System) station, or other medical imaging system. The processor 710 may be connected to a network 744, such as an intranet, the Internet, or an intranet connected to the Internet. The processor 710 may be interconnected to a customer system or a remote location via the network 744. The data processor 710 is provided for descriptive purposes and is not intended to limit the scope of the present system. The processor may have additional, fewer, or alternate components.

A computer program product 734 may reside on the memory 732 and include one or more sequences of executable code or coded instructions that are executed by the CPU 720. The program 734 may be loaded into the memory 732 from a storage device 736. The CPU 720 may execute one or more sequences of instructions of the program 734 to process data. Data may be input to the data processor 710 with the data input device 738, which may be a keyboard or a sensor, and/or received from the network 744. The program 734 may interface with the data input device 738 and/or the network 744 for the input of data. Data processed by the data processor 710 may be provided as an output to the display 740, the external output device 742, the network 744, and/or stored in a data base.

The program 734 and other data may be stored on, or read from, a machine-readable medium, including secondary storage devices such as hard disks, floppy disks, CD-ROMS, and DVDs; electromagnetic signals; or other forms of machine readable medium, either currently known or later developed. The program 734, memory 732, and other data may comprise and store a data base of files and data associated with a machine readable data base of a care plan, other patient data, best practice workflows, image data, and other medical data. The data base may be organized such that the information regarding worksteps within the care plan and associated data may be remotely searchable and retrievable via a search engine operating over a network, such as the network 744.

In an aspect, the data processor 710 may be operable to accept information and update the status of the care plan to account for worksteps performed at one or more medical facilities. The updated care plan also may be stored within a data base or other memory unit. An individual care plan (in digital data or machine readable form) may be received by the data processor 710 from the data base, data input device 738, the network 744, or another input device. After which, the data processor 710 may revise the care plan to create an updated individual care plan (in digital data or machine readable form) that may be stored in the memory 732, the storage device 736, or other storage unit.

Workstep data detailing the performance of specific worksteps within the care plan, such as textual information, physician notes and/or instructions to other physicians, prescriptions, follow-up care instructions, appointments, and image data associated with images of the patient acquired via a medical imaging device during the workstep, may be received from a remote medical facility by the data processor 710 via the data input device 738, the network 744, or another input device. The data processor 710 may display and/or modify the care plan using the data received.

The data processor 710 may integrate or otherwise combine workstep data received from a number of medical facilities regarding worksteps performed at each of the facilities. The data processor 710 may provide remote access to a best practice workstep via a user interface located at a distant medical facility. The best practice workstep may have corresponding text, audio, video, and/or graphical instructional information that is remotely reproducible. The integration of the data received from a number of medical institutions performing the care plan by the data processor 710 may be fully or partially automated.

The data processor 710 may accept search terms entered by a user, such as a patient identification number, and transfer data associated with the search terms to the remote medical facilities via the network 744, the output device 742, or other manner. Based upon the search terms and/or search logic and rules, the care plan of a specific patient may be retrieved from the data base by the data processor 710.

An up-to-date care plan may be transferred to a medical facility via the network 744, output device 742, or other manner. The care plans transferred may be in the form of machine readable graphical and/or textual representations, executable versions of software applications, data to alter software applications installed at the customers locations, stand alone applications, modifications or revisions to pre-existing applications, or other forms.

In an aspect, the care plan may relate to the integration of a clinical workflow across care settings. The care plan may be engineered to synchronize a number of processes and employ a user interface tailored to the needs of a customer. In one embodiment, the care plan may be implemented via an information technology (IT) solution, such as a Siemens Soarian Clinical Access™ that provides access to clinical repository data from Syngo™-enabled imaging workstations, and brings diagnostics and IT to a single workstation. Syngo™ is a medical imaging operating system and user interface that works with various imaging technology, while Soarian™ employs a browser enabled user interface modeled on Syngo™ for navigation of medical images, clinical, and financial data, with a common look and feel, in a patient-centric view.

In another aspect, the care plan may relate to processing images illustrating an enhanced region of interest within a patient. For example, various types of contrast medium may be administered to a medical patient. While the contrast medium is traveling through or collected within a region of interest, a series of scans or images of the region of interest of the patient may be recorded for processing and display by the software applications. The enhanced region of interest may show the brain, the abdomen, the heart and vascular system, the liver, a lung, a breast, the head, a limb or any other body area.

In general, the types of imaging processes or modalities that may be used to produce patient images or scans of internal regions of interest include radiography, angiography, computerized tomography, ultrasound and magnetic resonance imaging (MRI). Additional types of imaging processes that may be used include perfusion and diffusion weighted MRI, cardiac computed tomography, computerized axial tomographic, electron-beam computed tomography, radionuclide imaging, radionuclide angiography, single photon emission computed tomography (SPECT), cardiac positron emission tomography (PET), digital cardiac angiography (DSA), and digital subtraction angiography (DSA). Alternate imaging processes or combinations thereof may be used.

While the preferred embodiments of the invention have been described, it should be understood that the invention is not so limited and modifications may be made without departing from the invention. The scope of the invention is defined by the appended claims, and all devices and methods that come within the meaning of the claims, either literally or by equivalence, are intended to be embraced therein.

What is claimed is:

1. A method of facilitating cross institutional healthcare, the method comprising:
maintaining a data base of a care plan for an individual patient up-to-date by integrating medical information regarding worksteps associated with the care plan via a processor, the individual worksteps being capable of performance at one of two or more medical facilities; and
providing remote access to data associated with the data base of the care plan over a communications network such that the data base may be accessed to display a current status of the care plan.

2. The method of claim 1, wherein the medical information provides an overview of past care the patient has received and the current status indicates whether the individual worksteps have been completed, and a time and place of a next scheduled appointment for the patient.

3. The method of claim 1, the method comprising remotely searching a data base stored at a first medical facility from a second medical facility over the communications network to obtain information regarding healthcare information of the patient not related to the care plan provided to the patient at the first medical facility.

4. The method of claim 1, comprising sharing electronic information among the medical facilities regarding the patient by using the patient's health insurance identification number or national identification number as a link between electronic files.

5. The method of claim 1, the method comprising:
transferring data regarding textual information and internal images of the patient associated with a performance of a workstep at a first medical facility over the communications network to a second medical facility; and
displaying the textual information and internal images at the second medical facility.

6. The method of claim 1, wherein the care plan provides for the detection and treatment of cardiovascular disease (CAD).

7. A method of facilitating cross institutional healthcare, the method comprises:
updating a data base of a care plan for an individual patient using workstep data associated with a performance of a workstep within the care plan at a first medical facility; and
providing remote access to data associated with the updated data base of the care plan over a communications network such that at least a portion of the updated data base may be reproduced at a second medical facility to display information regarding the performance of the workstep within the care plan performed at the first medical facility.

8. The method of claim 7, the method further comprising:
providing remote access to a searchable data base of medical information regarding information about the patient gathered by and stored by the first medical facility; and
remotely searching the searchable data base from the second medical facility.

9. The method of claim 7, the method further comprising:
setting up an appointment for the patient from the first medical facility by entering a date and place of the appointment via a user interface; and
remotely viewing the date and place of the appointment via a display at the second medical facility.

10. The method of claim 7, the method further comprising:
remotely tracking a current status of the patient among a plurality of medical facilities; and
displaying a data base of the current status within the updated data base of the care plan at one or more of the medical facilities.

11. The method of claim 10, the method comprising:
displaying information detailing recommended performances of worksteps within the care plan at one or more of the medical institutions via a user interface.

12. The method of claim 7, wherein the care plan involves the use of a medical imaging device to acquire internal images of the patient.

13. The method of claim 8, wherein the care plan provides for the detection and treatment of cardiovascular disease (CAD).

14. A data processing system for providing cross-institutional healthcare, the system comprising:
a data processor operable to:
remotely receive data from a plurality of medical facilities regarding a care plan for a patient over a communications network, the care plan comprising worksteps to be performed among the plurality of medical facilities;
maintain a current status of the care plan for the patient up-to-date using the data received; and
provide remote access to a machine readable data base of the up-to-date care plan over the communications network such that each of the plurality of medical facilities may locally reproduce the machine readable data base of the up-to-date care plan.

15. The data processing system of claim 14, wherein the processor is operable to maintain the care plan up-to-date by using an identification number associated with the patient as an electronic link between files stored among the plurality of medical facilities.

16. The data processing system of claim 14, wherein the processor is operable to remotely mine data stored at one medical facility of the plurality of medical facilities from another medical facility of the plurality of medical facilities.

17. The data processing system of claim 14, wherein the processor is operable to present textual information related to and images acquired during a past performance of a workstep within the care plan already performed at a different medical facility.

18. The data processing system of claim 14, wherein the processor is operable to present instructions, on a display, regarding performance of a workstep within the care plan that is yet to be performed.

19. A computer program product having instructions stored on a—readable medium, the product causing a computer to be operable to perform the method comprising:
updating a data base of a care plan for a patient using workstep data regarding performance of a workstep associated with the care plan at a first medical facility; and
providing remote access to the updated data base of the care plan such that at least a portion of the updated data base of the care plan may be reproduced to display a current status of the care plan at a second medical facility.

20. The computer program product of claim 19, wherein the instructions further comprise:
accepting input data entered via a user interface.

21. The computer-program product of claim 19, the instructions configuring the computer to accept and store textual information regarding a performance of a workstep and to accept and store image data associated with the performance of the workstep for subsequent reproduction at a remote location, the image data being acquired via a medical imaging device.
